(19) United States
(12) Patent Application Publication
(10) Pub. No.: US 2026/0099564 A1
(43) Pub. Date: Apr. 9, 2026

(54) SYSTEM AND METHOD FOR MODELING AND OPTIMIZING OPERATION OF NON-LINEAR PROCESS USING QUADRATIC POLYNOMIAL EQUATION WITH COEFFICIENTS AND ECONOMIC LOAD ALLOCATION

(71) Applicant: Honeywell International Inc., Charlotte, NC (US)

(72) Inventors: Peter Hart, Kells Meath (IE); Avijit Das, Bangalore (IN); Mandar Vartak, Bangalore (IN); Shweta Ramakrishna Bhat, Bangalore (IN)

(73) Assignee: Honeywell International Inc., Charlotte, NC (US)

(21) Appl. No.: 18/906,975

(22) Filed: Oct. 4, 2024

(51) Int. Cl. G06F 17/11

(52) U.S. Cl. CPC G06F 17/11

(57) ABSTRACT

A system comprises: processor(s); and memory(s) communicatively coupled to the processor(s), the memory(s) storing computer readable instructions that when executed by the processor(s) causes the processor(s) to: receive at least one user defined quadratic polynomial equation modeling a specific model for operation of a non-linear process; receive updated coefficients for the at least one user defined quadratic polynomial equation modeling the specific model for the operation of the non-linear process; perform an economic load allocation based on the updated coefficients and the at least one user defined quadratic polynomial equation modeling the specific model for the operation of the non-linear process; derive optimized targets for at least one manipulated variable of the non-linear process based on the economic load allocation; and provide the optimized targets to hardware that adjusts the operation of the non-linear process.

### BACKGROUND

Processes can be optimized in various ways. Mathematical models used in Advanced Process Control (APC) and optimization for process industries may be regularly updated to adapt to changing plant operating conditions. Development of mathematical models may follow a standardized process to result in seamless synchronization between online modeling and real time operations.

### SUMMARY

A system comprises: at least one processor; and at least one memory communicatively coupled to the at least one processor, the at least one memory storing computer readable instructions that when executed by the at least one processor causes the at least one processor to: receive at least one user defined quadratic polynomial equation modeling a specific model for operation of a non-linear process; receive updated coefficients for the at least one user defined quadratic polynomial equation modeling the specific model for the operation of the non-linear process; perform an economic load allocation based on the updated coefficients and the at least one user defined quadratic polynomial equation modeling the specific model for the operation of the non-linear process; derive optimized targets for at least one manipulated variable of the non-linear process based on the economic load allocation; and provide the optimized targets to hardware that adjusts the operation of the non-linear process.

A method comprises: receiving at least one user defined quadratic polynomial equation modeling a specific model for operation of a non-linear process; receiving updated coefficients for the at least one user defined quadratic polynomial equation modeling the specific model for the operation of the non-linear process; performing an economic load allocation based on the updated coefficients and the at least one user defined quadratic polynomial equation modeling the specific model for the operation of the non-linear process; deriving optimized targets for at least one manipulated variable of the non-linear process based on the economic load allocation; and providing the optimized targets to hardware that adjusts the operation of the non-linear process.

A non-transitory computer-readable medium including a set of instructions that, when executed by at least one processor, cause the at least one processor to: receive at least one user defined quadratic polynomial equation modeling a specific model for operation of a non-linear process; receive updated coefficients for the at least one user defined quadratic polynomial equation modeling the specific model for the operation of the non-linear process; perform an economic load allocation based on the updated coefficients and the at least one user defined quadratic polynomial equation modeling the specific model for the operation of the non-linear process; derive optimized targets for at least one manipulated variable of the non-linear process based on the economic load allocation; and provide the optimized targets to hardware that adjusts the operation of the non-linear process.

### BRIEF DESCRIPTION OF DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram illustrating an example system.

FIG. 2 shows a diagram having optimization objectives and/or factors (such as efficiencies and/or economics) used during optimization of an Advanced Process Control (APC) within a specific operating envelope.

FIG. 3 is an example method for providing optimized targets to hardware to adjust operation of a non-linear process modeled using user defined quadratic polynomial equation(s) with corresponding coefficients.

FIG. 4 is a block diagram illustrating example computing system(s) used to implement elements of the example system of FIG. 1.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

In examples, process control is used within process industries, such as power generation, oil and mineral extraction and refining, petrochemical production, chemical production, pharmaceutical production, food production and processing, semiconductor manufacturing, device assembly, etc. In examples, process controls are implemented within a process control system, which may be implemented, at least in part, within a distributed control system (DCS), programable logic controller (PLC), and/or supervisory control system. In examples, Advanced Process Control (APC) applies control theory to industrial process control systems. In examples, Advanced Process Control (APC) is used in addition to basic process controls. In examples, basic process controls may be built with the process itself to facilitate basic control, operation, and automation requirements. In examples, Advanced Process Control (APC) is added to the basic process controls to improve performance and/or economics of a process. In examples, Advanced Process Control (APC) technology may include any of advanced regulatory control (ARC), advanced process control (APC), multivariable model predictive control (MPC), nonlinear multivariable model predictive control (MPC), sequential control, and/or intelligent control.

In examples, Advanced Process Control (APC) technology uses mathematical models to model and simulate the operation of process(es) in process industries. In examples, Advanced Process Control (APC) technology uses modeling and simulation of the mathematical models to predict future events within the process(es) in the process industries. In examples, the mathematical models are used as a process simulation model to digitally model the fields of power generation, oil and mineral extraction and refining, petrochemical production, chemical production, pharmaceutical production, food production and processing, semiconductor manufacturing, device assembly, etc. In examples, the mathematical models may be modelled after the particular process(es). In examples, multiple mathematical models may be used to model and simulate a single process. In examples, a single mathematical model may be used to model and simulate each process. In examples, the mathematical models used in Advanced Process Control (APC) and optimization for process industries are regularly updated to adapt to changes within the process(es).

In examples, the changes to the process(es) include changes to the operating conditions of the process(es). In examples, the operating conditions of the process(es) may change because of changes in the actual process(es) (such as changes in a temperature of the process(es), flow of the process(es), pressure of the process(es), etc. within the actual process(es)). In examples, the operating conditions of the process(es) may change because of changes in the desired operation of the process (such as desired increase in throughput of the process(es), a desired increase in yield of the process(es), a desired minimization of energy consumption of the process(es), a desired increase in efficiency of the process(es), an increase in quality of the output of the process(es), and/or other desired metrics of the process, such as economic and profit driven metrics). In examples, Advanced Process Control (APC) takes a number of inputs relating to a process and changes in the inputs to the process(es) to predict what is going to happen with the process(es) in the future. In examples, Advanced Process Control (APC) can take many inputs and predict many outputs for a single process or for a plurality of processes. In examples, a primary process may have a number of sub-processes within it. In examples, inputs include independent variables (such as manipulated variables (MVs)) and outputs include dependent variables (such as control variables (CV)).

In examples, Advanced Process Control (APC) provides Economic Load Allocation (ELA) for equipment (such as boilers and turbines in powerplants) via Advanced Energy Solution (AES). In examples in powerplants, Advanced Energy Solution (AES) may distribute steam between boilers and turbines to minimize the total cost of electrical production using Economic Load Allocation (ELA). In examples, determinations regarding steam distribution between boilers and turbines to minimize the total cost of electrical production may be achieved, at least in part, by utilizing online non-linear dynamic efficiency models. In examples, the non-linear dynamic efficiency models are used within the primary Master Process Controller (MPC) to dynamically drive the boilers and turbines to meet the required electrical demand at the lowest cost.

In examples, Advanced Process Control (APC) systems are configured to look at efficiency curves of boilers and turbines to drive toward a global maximum efficiency. In examples, a number of different boilers and turbines are present at a plant or utility. In examples, it is desirable to consider the combined efficiency across the plant or utility (such as including a plurality of different boilers and turbines) to extract the maximum benefits or run at the lowest cost. In examples, non-linear dynamic efficiency models are used by the Advanced Process Control (APC) to take into account the combined efficiency across the plant or utility (such as including a plurality of different boilers and turbines). In examples, meeting the required electrical demand at the lowest cost can maximize efficiency and/or operating profits for a powerplant.

In examples, an Advanced Process Control (APC) includes a Plant Wide Optimizer (PWO) and a Process Controller (PC). In examples, the Plant Wide Optimizer (PWO) and/or Process Controller (PC) are designed to push process units and process plants to their optimal operating points to improve efficiency, quality, or other aspects of processes. In examples, these functionalities ensure that the process(es) is controlled within user defined constraints to ensure safe and effective operation of the process(es), while continuously pushing the process(es) towards optimal operating point(s). In examples, Plant Wide Optimizers (PWOs) and/or Process Controllers (PCs) facilitate real time data collection from process units and process plants during operation. In examples, Plant Wide Optimizers (PWOs) and/or Process Controllers (PCs) drive the process(es) through variables known as manipulated variables (MV). In examples, Plant Wide Optimizers (PWOs) and/or Process Controllers (PCs) monitor constraints that bound and set constraints on the operation of the process(es) through controlled variables (CV). In examples, Plant Wide Optimizers (PWOs) and/or Process Controllers (PCs) make use of disturbance variables (DV) to improve predictions and take pre-emptive action to maintain the process(es) within constraints that bound and set constraints on the operation of the process(es).

In examples, Plant Wide Optimizers (PWOs) and/or Process Controllers (PCs) include online optimization capabilities, which provide users with the ability to push the process(es) in real time to the optimal operating point for the operation of the process(es). In examples, the optimal operating point may change based on process(es) disturbances resulting from changes in processing conditions (such as changes in processing conditions due to feed stock changes, equipment health, product demand, and changes to environmental conditions). In examples, this tight integration of control and optimization allows the industrial unit or plant to operate optimally within safety, equipment, and quality constraints that bound and set constraints on the operation of the process. In examples, this versatility allows users to change the optimization coefficients in the online Advanced Process Control (APC) based on changes in conditions to manage process variability and ensure operational efficiency.

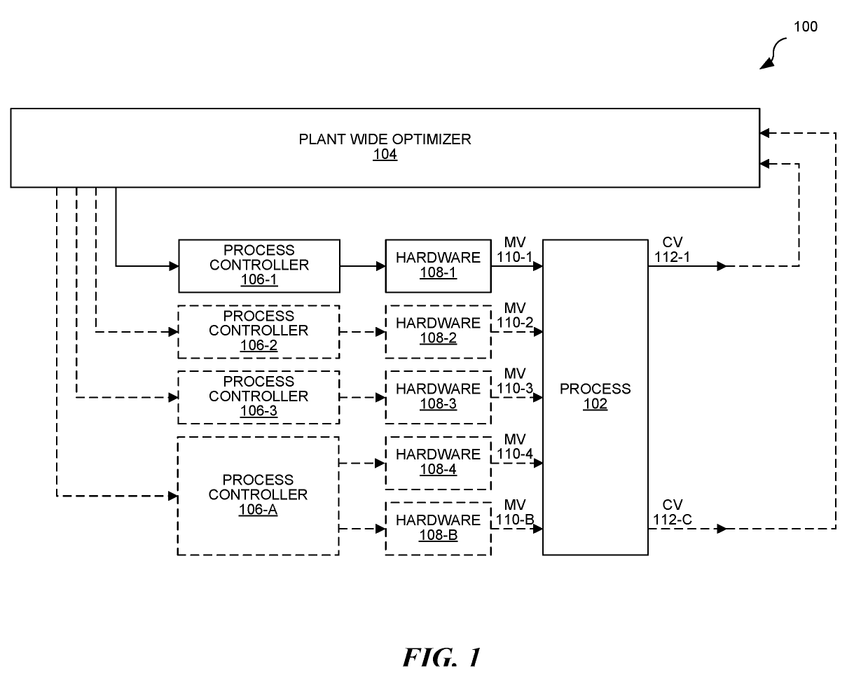

FIG. 1 is a block diagram illustrating a system 100. In examples, the system 100 is an Advanced Process Control (APC) system. In examples, the system 100 includes at least one process 102 controlled using at least one Plant Wide Optimizer (PWO) 104, at least one Process Controller (PC) 106 (such as Process Controller (PC) 106-1 and any combination of optional Process Controller (PC) 106 through optional Process Controller (PC) 106-A), and/or at least one hardware 108 (such as hardware 108-1 and any combination of optional hardware 108 through optional hardware 108-B). In examples, it is understood that the methodology and features described herein could be applied to various systems and that system 100 could have any quantity of process(es) 102, at least one Plant Wide Optimizer (PWO) 104, at least one Process Controller (PC) 106, and/or at least one hardware 108. In examples, the system 100 may include more than one process 102, more than one Plant Wide Optimizer (PWO) 104, more than one Process Controller (PC) 106, and/or more than one hardware 108 depending on the requirements and complexity of the system 100 and/or process(es) 102.

In examples, the at least one Process Controller (PC) 106 sits below the at least one Plant Wide Optimizer (PWO) 104. In examples, the Plant Wide Optimizer (PWO) 104 and/or Process Controller (PC) 106 are implemented in Advanced Process Control (APC) server(s) on-premises. In examples, the Plant Wide Optimizer (PWO) 104 and/or Process Controller (PC) 106 are distributed between different Advanced Process Control (APC) servers (such as different servers running at the plant control level). In examples, the Plant Wide Optimizer (PWO) 104 and/or Process Controller (PC) 106 are implemented on a single machine or server. In other examples, the Plant Wide Optimizer (PWO) 104 and/or Process Controller (PC) 106 are distributed across a plurality of machines or servers.

In examples, the at least one Process Controller (PC) 106 of the system 100 serves a unit level scope for a unit level of the at least one process 102. In examples, the at least one Process Controller (PC) 106 covers a piece of piece of equipment at a unit level. In examples, the at least one Process Controller (PC) 106 includes at least one unit level Master Process Controller (MPC) and/or at least one secondary Master Process Controller (MPC). In examples, the Process Controller (PC) 106 may be an oil well Advanced Process Controller (APC).

In examples, the at least one Plant Wide Optimizer (PWO) 104 of the system 100 covers a larger scope than the at least one Process Controller (PC) 106 of the system 100. In examples, the at least one Plant Wide Optimizer (PWO) 104 of the system 100 covers an entire plant scope, covering multiple pieces of equipment at a plant level. In examples, the at least one Plant Wide Optimizer (PWO) 104 of the system 100 is an overarching Master Process Controller (MPC).

In examples, the at least one process 102 has at least one associated manipulated variable (MV) 110 (such as manipulated variable MV 110-1 and any combination of optional manipulated variables MV 110 through manipulated variable MV 110-B). In examples, the at least one process 102 has at least one associated control variable (CV) 112 (such as control variable 112-1 and any combination of optional control variables CV 112 through optional control variable CV 112-C). In examples, the at least one manipulated variable (MV) 110 are input into the at least one process 102 from the left side. In examples, the control variables (CVs) 112 are output from the at least one process 102 on the right side. In examples, the at least one process 102 may be in a facility where temperature, flow controllers, and/or pressure controllers, etc. are controlling the at least one process 102. In examples, the at least one process 102 is controlled by adjusting certain inputs by manipulating manipulated variables (MVs) 110 to maintain the control variables (CVs) 112 output from the right of the at least one process 102.

In examples, each respective manipulated variable (MV) 110 (such as manipulated variable MV 110-1 or any other manipulated variable MV 110) is adjusted using respective hardware 108 (such as hardware 108-1 or any other hardware 108). In examples, each respective hardware 108 is implemented using physical structures and/or computer-programmed functionality using computer programable-circuitry and/or at least one computer-programable processor configured to implement all or part of the functionality described herein. In examples, each respective hardware 108 is implemented as an instantiation of computing system(s) 400 described herein. In examples, each respective hardware 108 is controlled by a respective Process Controller (PC) 106 and/or the at least one Plant Wide Optimizer (PWO) 104. In examples, each respective hardware 108 then adjusts something physical to move the respective manipulated variable MV 110 for the at least one process 102 based on the control from the respective Process Controller (PC) 106 and/or the at least one Plant Wide Optimizer (PWO) 104. In examples, at least some of the respective hardware 108 is configured to adjust something physical by adjusting one or more physical structure (such as adjusting the position of a gate, valve, etc.) to move the respective manipulated variable MV 110 for the at least one process 102 as desired.

In examples, the respective hardware 108 is implemented using at least one distributed control system (DCS), at least one programable logic controller (PLC), and/or at least one supervisory control system set points. In examples, the at least one Plant Wide Optimizer (PWO) 104 (and any additional at least one Plant Wide Optimizer (PWO) 104) is implemented using physical structures and/or programmed functionality using computer programable-circuitry and/or at least one computer-programable processor configured to implement all or part of the functionality described herein. In examples, the at least one Plant Wide Optimizer (PWO) 104 (and any additional at least one Plant Wide Optimizer (PWO) 104) is implemented as an instantiation of the computing system(s) 400 described herein. In examples, the at least one Plant Wide Optimizer (PWO) 104 is configured to coordinate control of the at least one process 102 being performed by the at least one Process Controller (PC) 106.

In examples, algorithms for the Plant Wide Optimizer (PWO) 104 and the Process Controller (PC) 106 have not historically used Economic Load Allocation (ELA) because Economic Load Allocation (ELA) was specifically designed to be implemented on fossil fuel power facilities. In examples, not utilizing Economic Load Allocation (ELA) is a significant limitation to users of Advanced Process Control (APC) technology in industries (other than fossil fuel power facilities) where load allocation over units with non-linear efficiency curves are present, such as: (1) a chemical plant with multiple reactors or processing trains; (2) mechanical efficiencies of pumps or turbines; (3) renewable energy systems; (4) upstream and downstream gas and oil processing facilities; and (5) clean energy systems like hydrogen power plant optimization.

In examples, the efficiency of renewable energy systems such as solar panel efficiency can be modelled using a quadratic function with respect to factors such as angle of incidence and temperature. In examples, chemical plant reaction yields may be modelled using a quadratic function with respect to factors such as reactant concentration, time or temperature due to competing effects of reaction kinetics and equilibrium. In examples, mechanical efficiencies of pumps or turbines may be represented using quadratic polynomials with respect to flow rate or speed of rotation. In examples, oil fields consist of up to hundreds of wells. In examples, each oil well has unique characteristics and oil production may be estimated using quadratic models taking many inputs into account, such as: (1) oil to gas ratio; (2) water; (3) field reservoir pressure; (4) gas re-injection; and (5) well head pressure. In examples, some of these inputs are measured via field transmitters in real time, while others are updated periodically as oil wells are tested in the field. In examples, cleaner energy systems like hydrogen power plants consist of numerous hydrogen fuel cells. In examples, non-linear efficiency curves of the hydrogen fuel cells may be derived for each cell.

In examples, it is currently difficult for plant operators to use linear control technology available in Plant Wide Optimizer (PWO) 104 and Process Controller (PC) 106 to solve these non-linear load distribution problems, which results in incomplete and less robust functionality and sub-optimal operation. In examples, an alternative approach can handle load allocation effectively in a wider sense. In examples, Economic Load Allocation (ELA) (such as ELA-Open) is integrated into Advanced Process Control (APC) to improve maintainability and offer a field wide or plant wide non-linear optimization customizable solution.

In examples, Economic Load Allocation (ELA) is made available in a customizable way to plant operators for non-linear load distribution problems across different facilities (in addition to fossil fuel power generation facilities). In examples, Economic Load Allocation (ELA) is made available in a customizable way for use with: (1) chemical plants with multiple reactors; (2) a set of turbines or mechanical pumps that run in parallel; (3) renewable energy systems (such as hydrogen power plan optimization); and/or (4) upstream or downstream oil and gas processing facilities (such as oil wells and/or gas wells in large fields for extraction). In examples, there are constraints on the inputs to the processes, such as injection gas to maximize production of gas and/or oil. In examples, the customizable Economic Load Allocation (ELA) can be implemented with any process with a nonlinear efficiency curve that can be defined using a quadratic polynomial. In examples, the efficiency curves are implemented with the quadratic polynomial (such as a convex curve) instead of linear equations. In examples, Economic Load Allocation (ELA) can be used to push the overall efficiency to optimum points based on non-linear efficiency curves.

In examples, instead of having a fixed linear equation, users of the system implementing the customizable Economic Load Allocation (ELA) can enter a specific efficiency model using quadradic polynomials, rather than using a fixed quadratic polynomial efficiency model (such as those specifically derived for boilers and turbines). In examples using the customizable and open Economic Load Allocation (ELA), users can essentially use what they would use in the plant to represent efficiency to create the specific efficiency model using quadratic polynomials. In examples, real time values can be linked up to the efficiency models. In examples, the efficiency models and their associated coefficients can be updated after periodic checks on the equipment of well and/or processing facilities on a regular basis (such as testing every few months).

In examples, the coefficients can be updated in a single file that will bulk update all the models that are being used in the Advanced Process Control (APC) (such as for hundreds of wells or units). In examples, the single bulk update of the models and/or coefficients results in a lower likelihood of entry errors than if the coefficients and/or models are updated by operators or engineers manually. In examples, the coefficient updating occurs at a software application level, either at single Plant Wide Optimizer (PWO) level (which could span a number of units or literally hundreds of wells) or at a Process Controller (PC) level. In examples, it may take only a couple of coefficients to model the efficiency. In examples, it may take many coefficients (such as between 20-30) to model the efficiency, depending on what the curve looks like. In examples, users across industries can use the same customizable Economic Load Allocation (ELA) to flexibly implement the Economic Load Allocation (ELA) for their specific process.

In examples, an open calculation engine from Advanced Process Control (APC) and corresponding variables calculated in the process controller are used. In examples, users can use this to specify the efficiency models using applicable quadratic polynomial models and the derivatives of the applicable quadratic polynomial models to calculate optimization coefficients. In examples, the calculated optimization coefficients are used by the Advanced Process Control (APC) to drive field or plant wide optimization. In examples, these models are linked to live measurements via Open Platform Communications (OPC), such as OPC Data Access (OPC DA) or OPC Unified Architecture (OPC UA) technology, which means the curves and calculated optimization coefficients will be updated in real-time in a Unified Real Time (URT) execution environment of the Advanced Process Control (APC). In examples, the curves are then shown to operators via a web interface for the Advanced Process Control (APC) with a plot of the current operating point on the current curve to give the operations staff real time feedback on the current health of the unit. In examples, the operators may need to maintain the system by updating thousands of model coefficients as field tests are completed giving updated parameterization. In examples, this is not only tedious but also prone to manual error. In examples, this innovation ensures that the model coefficients can be bulk updated to the Advanced Process Control (APC), reducing the maintenance burden and ensuring a more robust system. In examples, an example oil field using dynamical well curves can be optimized.

In examples, a cascaded approach is used to have a Plant Wide Optimizer (PWO) 104 that sends targets down to individual Process Controllers (PCs) 106 (secondary Advanced Process Controls (APCs)). In examples, there are multiple Process Controllers (PCs) 106 (multiple secondary Advanced Process Controls (APCs)). In examples, the system 100 could include hundreds of Process Controllers (PCs) 106 (secondary Advanced Process Controls (APCs)). In examples, the system 100 is running the efficiency curve calculation at the Plant Wide Optimizer (PWO) 104 level such that the curves are updated in the Plant Wide Optimizer (PWO) 104 application as opposed to looking at the individual Process Controller (PC) 106 (secondary Advanced Process Controls (APCs)). Previously, all the coefficients would have had to be entered separately at an individual unit (such as a boiler or turbine or other hardware 108) to update the individual unit (such as a boiler or turbine or other hardware 108). Now, a bulk update across all the units (such as wells or other hardware 108) can be used to update many (such as hundreds or more) of units (such as wells or other Process Controllers (PCs) 106 (secondary Advanced Process Controls (APCs))) in a single process. In examples, the bulk update updates a configuration file on all the wells through a network.

In examples, a file is downloaded to the Plant Wide Optimizer (PWO) 104 and/or Process Controllers (PCs) 106 (secondary Advanced Process Control (APC)) and the new model coefficients are read into the application. In examples where the bulk update is provided to the Plant Wide Optimizer (PWO) 104, the updated coefficients provided to the Plant Wide Optimizer (PWO) 104 are used to calculate new targets via a network from the Plant Wide Optimizer (PWO) 104 to all of the Process Controllers (PCs) 106 (secondary Advanced Process Control (APC)). The Process Controllers (PCs) 106 (secondary Advanced Process Control (APC)) then follow the globally derived targets by then adjusting distributed control system (DCS), programable logic controller (PLC), and/or supervisory control system set points. In examples, the cascaded approach (using both the Plant Wide Optimizer (PWO) 104 and the Process Controllers (PCs) 106) is useful because it allows for distribution of the controls, but it is not necessary that the Process Controllers (PCs) 106 (secondary Advanced Process Control (APC)) be an Advanced Process Control (APC). In examples, the models are updated in a single application.

In examples, the Process Controllers (PCs) 106 (secondary Advanced Process Control (APC), such as a well controller) is focused on the unit level constraints. In examples, the Plant Wide Optimizer (PWO) 104 is focused on the global constraints and the global demand. In examples, the coefficients that are calculated from these curves are used to drive each individual well to the optimal operating point on the efficiency curves. In examples implementing the cascaded approach, all of the Economic Load Allocation (ELA) is being driven by the plant wide optimizer implemented through targets to the secondaries (such as secondary Advanced Process Control (APCs)).

In examples, the targets are essentially derived at the Plant Wide Optimizer (PWO) 104 level and influenced by the bulk update done at the Plant Wide Optimizer (PWO) 104 level. In examples, the targets thusly take the efficiency curves into account at this level. In some examples, the efficiency curves are run at the Process Controllers (PCs) 106 (secondary Advanced Process Control (APC)) level without the Plant Wide Optimizer (PWO) 104 level. In examples, a Plant Wide Optimizer (PWO) 104 is not needed and the efficiency curve models are implemented at the Process Controllers (PCs) 106 (secondary Advanced Process Control (APC)) portion.

In examples, the optimization coefficients are linearized based on the current operation to solve the global load allocation problem. In examples, optimal distribution of a global resource (such as gas lift) allows operation in a more efficient fashion than if these were not taken into account. In examples, this methodology assists with more optimal operation and reduces commissioning periods. In examples, this can be implemented using the cascaded approach (or not) on a number of different processes.

In examples, the efficiency curves are linked to real time readings that are on the process via OPC communications. In examples, if you increase the gas that flows into a well, you increase your oil production up to a point after which you then start losing production and efficiency. In examples, the curves are a function of various inputs. In examples, some of the inputs are read via the control network via OPC. In examples, other inputs are updated by well engineers after performing the periodic well tests. In examples, the actual model is updated periodically.

In examples, an example cascaded approach to implement load allocation solutions includes: (1) a unique Plant Wide Optimizer (PWO) 104 (Primary) taking care of optimal load allocation to satisfy global objectives while maintaining global constraints; and (2) Process Controllers (PCs) 106 (Secondaries) utilized to follow global targets by manipulating setpoints of local Distributed Control System (DCS) and/or local Programmable Logic Controller (PLC) controllers, while ensuring local constraints are not violated. In examples, conjoint variable technology is used to back propagate secondary constraints to the Plant Wide Optimizer (PWO) 104, ensuring that optimal distribution not only takes the custom efficiency curves into account, but also takes local constraints into account at a global level using proxy limits which are calculated on each Process Controllers (PCs) 106. In examples, proxy limits from the Process Controllers (PCs) 106 are propagated to the Plant Wide Optimizer (PWO) 104, which allows for awareness of the operating envelopes of the secondary controllers at the plant wide level. In examples, Economic Load Allocation (ELA) (such as ELA-Open) I used to drive the conjoint connections (such as of conjoint manipulated variables (MVs)) between the Plant Wide Optimizer (PWO) 104 and the Process Controllers (PCs) 106. In examples using the cascaded approach, proxy limits for the Plant Wide Optimizer (PWO) 104 are propagated via conjoint links (such as through conjoint manipulated variables (MVs)) to the Process Controllers (PCs) 106. In examples, individual constraints on units (such as wells) can be mapped to proxy limits. In examples using the cascaded approach, targets are propagated (sent down) from the Plant Wide Optimizer (PWO) 104 to the Process Controllers (PCs) 106 via the conjoint variables (such as conjoint manipulated variables (MVs)). In examples, this strategy improves ease of deployment and maintainability. In examples, an Economic Load Allocation (ELA) (such as ELA-Open) makes the cascaded Plant Wide Optimizer (PWO) 104 and Process Controllers (PCs) 106 solution more applicable to a variety of industrial sites as demonstrated in the aforementioned examples.

In examples, the Economic Load Allocation (ELA) (such as ELA-Open) transformations in a Plant Wide Optimizer (PWO) 104 are used to linearize optimization coefficients based on the current operating point of each well or cell. In examples, this allows the Plant Wide Optimizer (PWO) 104 to solve the global load allocation of economically non-linear processes. In examples, this feature is seamlessly integrated with the existing Process Controllers (PCs) 106 and Plant Wide Optimizer (PWO) 104, requiring very little additional effort from the user to set up the curves for each train. In examples, the Process Controllers (PCs) 106 and/or Plant Wide Optimizer (PWO) 104 automatically use the load allocation coefficients to drive to a global optimum, making the Advanced Process Control (APC) more versatile and user-friendly. In examples, the coefficients can be updated easily using a master coefficient file which removes the risk of errors associated with manual updates, leading to more reliable and efficient control.

In examples, this innovation addresses the existing limitations and enhances the robustness and overall functionality of Plant Wide Optimizer (PWO) 104 and Process Controllers (PCs) 106 making them more applicable to a wider range of processes. In examples, inclusion of Economic Load Allocation (ELA) (such as ELA-open) in Advanced Process Control (APC) ensures more optimal and consistent control of facilities with multiple trains, such as: (1) chemical plants; (2) renewable energy facilities; (3) mechanical systems; (4) oil and gas processing; and (5) Hydrogen power plants. In examples, this innovation will assist in reduction of commissioning periods and minimize operational risks through the standard implementation methodology.

In examples, this advancement significantly enhances the capability of the Plant Wide Optimizer (PWO) 104 and Process Controllers (PCs) 106 by enabling economic non-linear and linear optimization with equal proficiency. In examples, this results in better control performance, reduced maintenance efforts and an overall more robust control system. In examples, Economic Load Allocation (ELA) means utilizing the most efficient assets most effectively, leading to lower operation costs and increased productivity (which can result in more profit for operators).

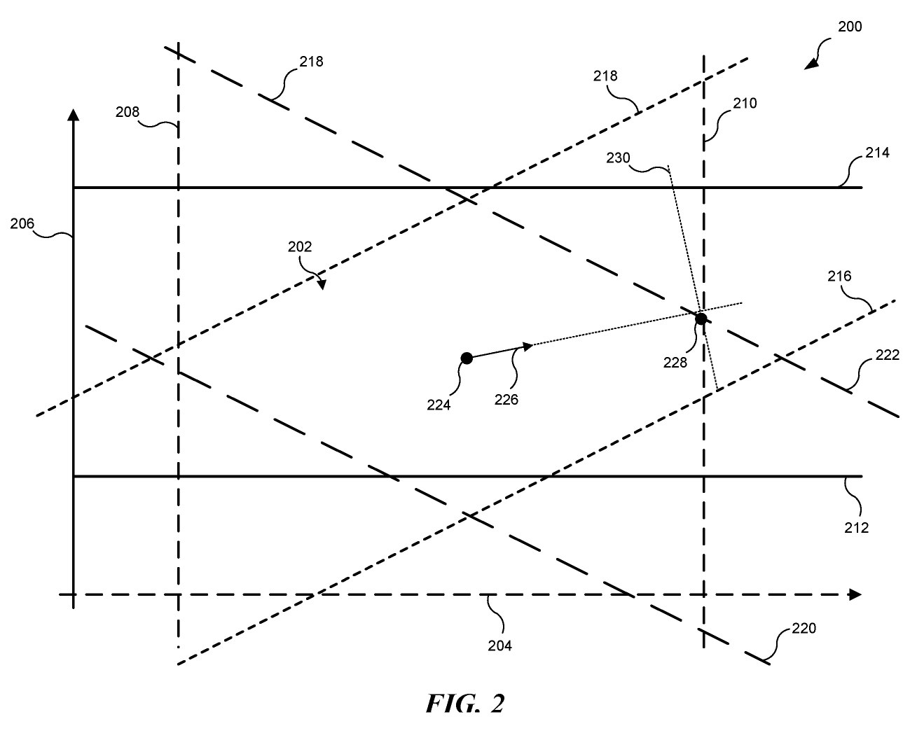

FIG. 2 shows a diagram 200 having optimization objectives and/or factors (such as efficiencies and/or economics) used during optimization of an Advanced Process Control (APC) within a specific operating envelope 202. In examples, the operating envelope 202 is shown in the center of the diagram 200. In examples, the operating envelope 202 represents the space within which a process is being driven toward a specific point based on efficiencies, economics, or other goals. In examples, the process is optimized to extract the maximum efficiency. In examples, the process is driven toward a specific spot in the operating envelope. In examples, diagram 200 shows a super-position of controlled variables (CVs) onto a manipulated variables (MVs) space. In examples, the x-axis 204 of diagram 200 is for a manipulated variable (MV) 1. In examples, the y-axis 206 of diagram 200 is for a manipulated variable (MV) 2.

In examples, diagram 200 shows a lower bound for a manipulated variable (MV) 1 as MV 1 Low 208. In examples, diagram 200 shows a higher bound for the manipulated variable (MV) 1 as MV 1 High 210. In examples, diagram 200 shows a lower bound for a manipulated variable (MV) 2 as MV 2 Low 212. In examples, diagram 200 shows a higher bound for the manipulated variable (MV) 2 as MV 2 High 214. In examples, diagram 200 shows a lower bound for a controlled variable (CV) 1 as CV 1 Low 216. In examples, diagram 200 shows a higher bound for the controlled variable (CV) 1 as CV 1 High 218. In examples, diagram 200 shows a lower bound for a controlled variable (CV) 2 as CV 2 Low 220. In examples, diagram 200 shows a higher bound for a controlled variable (CV) 2 as CV 2 High 222. In examples, diagram 200 shows the current operating position 224 within the operating envelope 202. In examples, diagram 200 shows the direction of the movement 226 of the current operating position 224 toward an optimized operating position 228. In examples, diagram 200 shows a contour of equal cost 230.

In examples, the operating envelope 202 is derived from the objective coefficients (which is an optimization objective function). In examples, optimization objectives can be setup to push efficiency, costs, etc. depending on what the Key Performance Indicators (KPIs) are for a particular process. In examples where the optimization objective is energy savings, the optimization will be designed to minimize energy consumption to increase energy efficiency. In examples where the optimization objective is to maximize throughput, the optimization will be designed to maximize throughput, even if it is not the most energy efficient option.

In examples, modifications to the operation of the at least one process 102 are implemented in part using the at least one Plant Wide Optimizer (PWO) 104. In examples, the modifications to the operation of the at least one process 102 are implemented in part by the at least one Plant Wide Optimizer (PWO) 104 being configured to adjust set point values within the hardware 108 (such as set point circuitry(s)) to inject or excite the manipulated variables (MVs) 110, which then effects the control variables (CVs) 112 of the at least one process 102. In examples, the at least one Plant Wide Optimizer (PWO) 104 is automated to require minimal user input to improve the quality of the models and thereby improve the control of the at least one process 102.

In examples, the Process Controller (PC) 106 (and any additional Process Controller (PC) 106) is implemented using physical structures and/or programmed functionality using computer programable-circuitry and/or at least one computer-programable processor configured to implement all or part of the functionality described herein. In examples, the Process Controller (PC) 106 (and any additional Process Controller (PC) 106) is implemented as an instantiation of the computing system(s) 400 described herein. In examples, there are constraints that bound and set constraints on the operation of the at least one process 102. In examples, it is desirable to optimize the at least one process 102 by manipulating where the at least one process 102 operates within the constraints that bound and set constraints on the operation of the at least one process 102. In examples, it may be desirable to keep the at least one process 102 operating as far from possible from any constraints that bound and set constraints on the operation of the at least one process 102. In examples, the Process Controller (PC) 106 attempts to push the at least one process 102 to operate nearer to the constraints that bound and set constraints on the operation of the at least one process 102 so that the at least one process 102 can operate in a more optimized way. In examples, the Process Controller (PC) 106 is configured to push the at least one process 102 to operate nearer to the constraints that bound and set constraints on the operation of the at least one process 102 by increasing throughput of the at least one process 102, increasing yield of the at least one process 102, minimizing energy consumption of the at least one process 102, increasing efficiency of the at least one process 102, increasing quality of the output of the at least one process 102, and/or being optimized in other ways, such as economically. In examples, operating the at least one process 102 in the more optimized way pushes the operation of the at least one process 102 closer to, without crossing, the constraints that bound and set constraints on the operation of the at least one process 102. In examples, the Process Controller (PC) 106 is configured to mathematically model the at least one process 102 based on the manipulated variables (MVs) 110 and the control variables (CVs) 112. In examples, the mathematical models generated by the Process Controller (PC) 106 include the constraints that bound and set constraints on the operation of the at least one process 102. In examples, the Process Controller (PC) 106 is configured to use an optimization objective function to allow users to manipulate optimization coefficients to push the operation of the at least one process 102 in certain directions depending on current Key Performance Indicators (KPI).

In examples, the set point circuitry(s) 108 may include at least one Single-Input Single-Output (SISO) control loop. In examples, at least one Single-Input Single-Output (SISO) control loop within at least one hardware 108 is configured to determine a flow indication of properties of the flow of a substance (such as oil, gasoline, diesel fuel, natural gas, water, oxygen, gases, a liquid, a solid, a slurry, etc.). In examples, the at least one Single-Input Single-Output (SIS) control loop) is configured to manipulate the flow of the substance (such as oil, gasoline, diesel fuel, natural gas, water, oxygen, gases, a liquid, a solid, a slurry, etc.) by (1) adjusting a valve position; and/or (2) changing a speed of a pump (such as increasing the speed of the pump to increase flow); etc. In examples, once the flow of the substance reaches a specific set point (SP), the at least one Single-Input Single-Output (SIS) control loop) is configured to (1) stop moving or re-adjust the value (such as by closing the valve); or (2) stop operating or re-adjust the speed of the variable speed pump (such as by stopping the variable speed pump or lowering the speed of the variable speed pump to decrease flow). In examples, while set points can be manually derived, the at least one Plant Wide Optimizer (PWO) 104 is configured to automatically determine set points based on the mathematical models. In examples, the at least one Plant Wide Optimizer (PWO) 104 is configured to adjust the set points using the set point circuitry(s) 108 to achieve specific targets for the at least one process 102. In examples, the at least one Plant Wide Optimizer (PWO) 104 is multi-variable, meaning it can analyze a number of variables (such as flows, temperatures, pressures, etc.) and then manipulate the entire process 102 (which may include an entire section of a plant or an entire plant) to push the variables (such as the control variables (CVs) 112 and/or the manipulated variables (MVs) 110) into the optimum position. In examples, the at least one Plant Wide Optimizer (PWO) 104 changes models over time if the models that are currently running the process become less relevant. In examples, feedback of the manipulated variables (MVs) 110 and the control variables (CVs) 112 for the at least one process 102 is provided to the at least one Plant Wide Optimizer (PWO) 104 to re-model the at least one process 102. In examples, re-modeling of the at least one process 102 in the at least one Plant Wide Optimizer (PWO) 104 includes re-modeling the relationships between the manipulated variables (MVs) 110 and the control variables (CVs) 112 so that the at least one Plant Wide Optimizer (PWO) 104 can adapt the at least one process 102 to the current operating range and/or current operating functionalities.

In examples, the Process Controller (PC) 106 writes to set points (SP) within the set point circuitry(s) 108. In examples, the set point circuitry(s) 108 include proportional-integral-derivative (PID) loops housed within a distributed control system (DCS) or programable logic controller (PLC) and the set point values are written to the PID loops housed within the DCS or PLC as the layer of control just above a base layer control (BLC) of a process unit of the at least one process 102. In examples, transmitters within the system 100 measures things like flow, temperature, and/or pressure from the process. In examples, analyzers within the system 100 indicate quality. In examples, the transmitters and analyzers within the system 100 are wired into a control system with a number of inputs.

In examples, the Process Controller (PC) 106 and/or the at least one Plant Wide Optimizer (PWO) 104 are implemented using separate computing systems (such as separate servers and/or computers implemented as separate computing systems 400 as described herein). In examples, the Process Controller (PC) 106 and/or the at least one Plant Wide Optimizer (PWO) 104 are implemented using a single computing system (such as a single server and/or computer implemented as a single computing system 400 as described herein). In examples, the Process Controller (PC) 106 is implemented within a distributed control system (DCS).

In examples, there are two types of control variables (CVs) (such as any of control variables (CVs) 112): (1) self-regulating control variables (CVs); and (2) integrating control variables (CVs). In examples, self-regulating control variables (CVs) naturally settle at a steady state after a disturbance, while integrating control variables (CVs) exhibit a continuous drift in response to a sustained change, never settling at a new steady state on their own. In examples, self-regulating control variables (CVs) may include flow, temperature, and/or pressure, etc. In examples, it is desirable to maintain self-regulating control variables (CVs) within a certain range. In examples, a self-regulating control variable (CV) starts at a point, goes through a process, and then settles at equilibrium. In examples, self-regulating control variables (CVs) reach equilibrium after a certain point, such that they do not move anymore unless there are new disturbances or updates in manipulated variable(s) (MV) (such as manipulated variable MV 110).

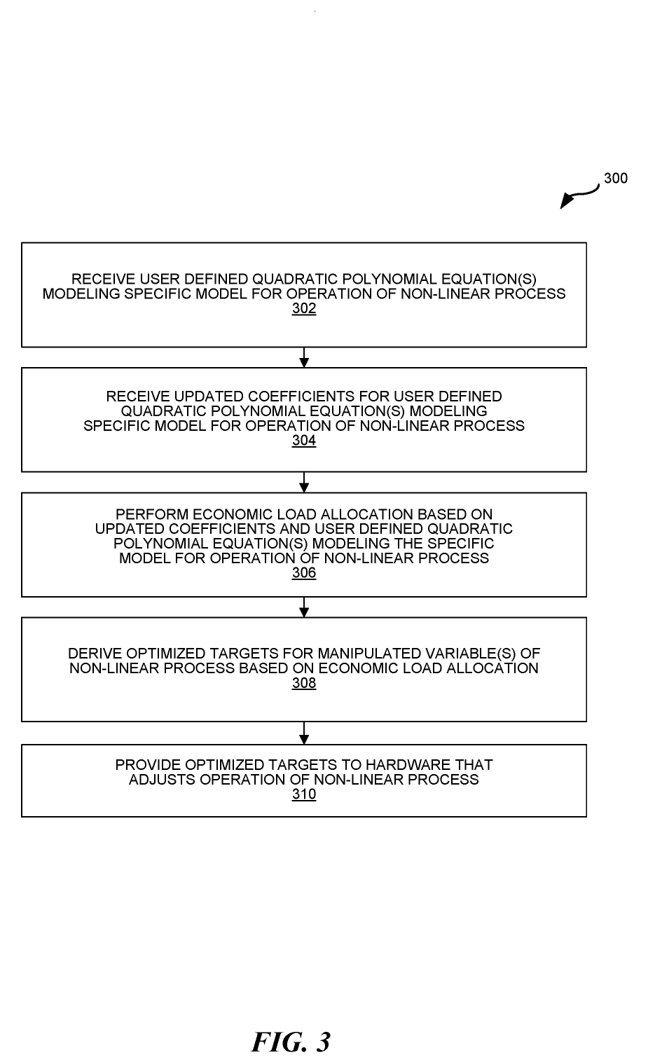

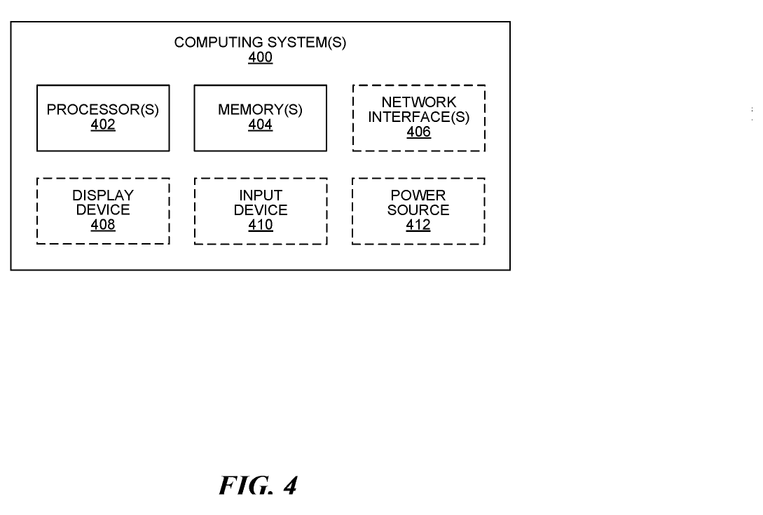

FIG. 3 is an example method 300 for providing optimized targets to hardware to adjust operation of a non-linear process modeled using user defined quadratic polynomial equation(s) with corresponding coefficients. In examples, the example method 300 is executed using any of system 100 and computing system(s) 400 described herein. In examples, the example method 300 is embodied, at least in part, in a set of instructions on a non-transitory computer-readable medium including instructions, that when executed by at least one processor, cause the at least one processor to perform the functionality described in example method 300. In examples, the non-transitory computer-readable medium can be any device, mechanism, or populated data structure used for storing information. In examples, the non-transitory computer-readable medium can be or include any type of volatile memory, nonvolatile memory, and/or dynamic memory, random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs), disc drives, flash drives, and/or the like. In examples, the at least one processor executing the instructions on the non-transitory computer-readable medium can be any known processor, such as a general purpose processor (GPP) or special purpose (such as a field-programmable gate array (FPGA), application-specific integrated circuit (ASIC) or other integrated circuit or circuitry), any programmable logic device, or any circuitry. In examples, the non-transitory computer-readable medium is implemented by the at least one memory 404 and the at least one processor is implemented by the at least one processor 402 shown in FIG. 4 and described below.

In examples, method 300 begins at block 302 with receiving at least one user defined quadratic polynomial equation modeling a specific model for operation of a non-linear process. In examples, the user defined quadratic polynomial equation modeling the specific model for operation of the non-linear process is received at the at least one Plant Wide Optimizer (PWO) 104. In examples, the user defined quadratic polynomial equation modeling the specific model for operation of the non-linear process is received at the at least one Process Controller (PC) 106. In examples, the user defined quadratic polynomial equation modeling the specific model for operation of the non-linear process is received via at least one network interface (such as network interface(s) 406 shown in FIG. 4 and described below). In examples, the user defined quadratic polynomial equation modeling the specific model for operation of the non-linear process is input by a user using a web interface or other software. In examples, the web interface or other software may include a representation of the efficiency curve and the current operation point for the non-linear process (such as process 102). In examples, the software may include an equation editor that can be used to add user defined quadratic polynomial equations (such as efficiency equations) and/or coefficients. In examples, calculations occur and the data is processed to calculate the models offline and then the models are seamlessly integrated into an online controller (such as a Plant Wide Optimizer (PWO) 104 and/or a Process Controller (PC) 106).

In examples, method 300 proceeds to block 304 with receiving updated coefficients for the at least one user defined quadratic polynomial equation modeling the specific model for the operation of the non-linear process. In examples, the updated coefficients drive the user defined quadratic polynomial equations to cause an update in the operation of the non-linear process (such as process 102 shown in FIG. 1 and described above). In examples, the updated coefficients are based on input/feedback from the operation of the non-linear process (such as process 102 shown in FIG. 1 and described above). In examples, the updated coefficients for the at least one user defined quadratic polynomial equation modeling the specific model for the operation of the non-linear process (such as process 102 shown in FIG. 1 and described above) are received at the at least one Plant Wide Optimizer (PWO) 104. In examples, the updated coefficients for the at least one user defined quadratic polynomial equation modeling the specific model for the operation of the non-linear process (such as process 102 shown in FIG. 1 and described above) are received at the at least one Process Controller (PC) 106. In examples, the updated coefficients for the at least one user defined quadratic polynomial equation modeling the specific model for the operation of the non-linear process (such as process 102 shown in FIG. 1 and described above) are received using a bulk update with the updated coefficients from the user. In examples, the bulk update with the updated coefficients from the user is received at the at least one Plant Wide Optimizer (PWO) 104. In examples, the bulk update with the updated coefficients from the user is received at the at least one Process Controller (PC) 106. In examples, the method 300 further includes generating the updated coefficients based on real-time feedback from the operation of the non-linear process (such as process 102 shown in FIG. 1 and described above). In examples, the updated coefficients for the at least one user defined quadratic polynomial equation modeling the specific model for the operation of the non-linear process are received are received via at least one network interface (such as network interface(s) 406 shown in FIG. 4 and described below).

In examples, the method 300 proceeds to block 306 with performing an economic load allocation based on the updated coefficients and the at least one user defined quadratic polynomial equation modeling the specific model for the operation of the non-linear process. In examples, performing an economic load allocation based on the updated coefficients and the at least one user defined quadratic polynomial equation modeling the specific model for the operation of the non-linear process is performed by the at least one Plant Wide Optimizer (PWO) 104. In examples, performing an economic load allocation based on the updated coefficients and the at least one user defined quadratic polynomial equation modeling the specific model for the operation of the non-linear process is performed by the at least one Process Controller (PC) 106.

In examples, the method 300 proceeds to block 308 with deriving optimized targets for at least one manipulated variable of the non-linear process based on the economic load allocation. In examples, deriving optimized targets for at least one manipulated variable of the non-linear process based on the economic load allocation is performed by the at least one Plant Wide Optimizer (PWO) 104. In examples, deriving optimized targets for at least one manipulated variable of the non-linear process based on the economic load allocation is performed by the at least one Process Controller (PC) 106.

In examples, the method 300 proceeds to block 310 with providing the optimized targets to hardware (such as hardware 108) that adjusts the operation of the non-linear process. In examples, providing the optimized targets to hardware is performed by the at least one Plant Wide Optimizer (PWO) 104 and the at least one Process Controller (PC) 106. In examples, the optimized targets are provided from the at least one Plant Wide Optimizer (PWO) 104 to the at least one Process Controller (PC) 106 and the at least one Process Controller (PC) 106 provide the optimized targets to the hardware (such as hardware 108) to adjust the operation of the non-linear process (such as process 102) across multiple sites. In examples, providing the optimized targets to hardware (such as hardware 108) is performed by the at least one Process Controller (PC) 106. In examples, the optimized targets are decimal values and the hardware (such as hardware 108) is configured to receive decimal values.

In examples, the hardware (such as hardware 108) includes at least one of a valve, a reactor, a pump, and a turbine. In examples, the optimized targets are used to adjusts something like a load (or the gas lift sent to each well). In examples, the hardware (such as hardware 108) implements the adjustments at a well level. In examples, the hardware 108 includes a single hardware (such as hardware 108-1). In examples, the hardware 108 includes a plurality of hardware (such as hardware 108-4 and hardware 108-B). In examples, the hardware (such as hardware 108) is remotely located from the at least one Plant Wide Optimizer (PWO) 104 and/or the at least one Process Controller (PC) 106. In examples, the optimized targets are provided to the hardware 108 via at least one network interface (such as network interface(s) 406 shown in FIG. 4 and described below).

In examples, the optimized targets are used to optimize the hardware (such as hardware 108) operation in whatever way the customer is looking to optimize the operation. In examples, the controlled variables (such as any controlled variable CV 112 or other feedback) are then fed back from the process 102 to the at least one Plant Wide Optimizer (PWO) 104 and/or the at least one Process Controller (PC) 106 to create curves used to update the updated coefficients that will be used to update the targets/set points to attempt to keep things optimized.

FIG. 4 is a block diagram illustrating example computing system(s) 400. The computing system(s) 400 includes at least one processor 402, at least one memory 404, optional at least one network interface 406, optional at least one display device 408, optional at least one input device 410, and optional at least one power source 412. In examples, any of the functionality disclosed herein may be implemented (at least in part) by the at least one processor 402 and the at least one memory 404. In examples, any of the at least one process 102, Process Controller (PC) 106, at least one Plant Wide Optimizer (PWO) 104, and/or hardware 108 can be implemented (at least in part) using the computing system(s) 400.

The at least one processor 402 can be any known processor, such as a general purpose processor (GPP) or special purpose (such as a field-programmable gate array (FPGA), application-specific integrated circuit (ASIC) or other integrated circuit or circuitry), any programmable logic device, or any circuitry. In examples, the at least one memory 404 can be any device, mechanism, or populated data structure used for storing information. In examples, the at least one memory 404 can be or include any type of volatile memory, nonvolatile memory, and/or dynamic memory. In examples, the at least one memory 404 can be random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs) and/or the like. In accordance with some embodiments, the at least one memory 404 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information, which can be used as the at least one memory 404. The at least one memory 404 may be used to store instructions for running one or more applications or modules on the at least one processor 402. In examples, the at least one memory 404 could be used in one or more examples to house all or some of the instructions needed to execute the functionality discussed herein.

In examples, the optional at least one network interface 406 includes or is coupled to optional at least one antenna for communication with a network. In examples, the optional at least one network interface 406 includes at least one of an Ethernet interface, a cellular radio access technology (RAT) radio, a Wi-Fi radio, a Bluetooth radio, or a near field communication (NFC) radio. In examples, the optional at least one network interface 406 includes a cellular radio access technology radio configured to establish a cellular data connection (mobile Internet) of sufficient speeds with a remote server using a local area network (LAN) or a wide area network (WAN). In examples, the cellular radio access technology includes at least one of Personal Communication Services (PCS), Specialized Mobile Radio (SMR) services, Enhanced Special Mobile Radio (ESMR) services, Advanced Wireless Services (AWS), Code Division Multiple Access (CDMA), Global System for Mobile Communications (GSM) services, Wideband Code Division Multiple Access (W-CDMA), Universal Mobile Telecommunications System (UMTS), Worldwide Interoperability for Microwave Access (WiMAX), 3rd Generation Partnership Projects (3GPP) Long Term Evolution (LTE), High Speed Packet Access (HSPA), third generation (3G) fourth generation (4G), fifth generation (5G), etc. or other appropriate communication services or a combination thereof. In examples, the optional at least one network interface 406 includes a Wi-Fi (IEEE 802.11) radio configured to communicate with a wireless local area network that communicates with the remote server, rather than a wide area network. In examples, the optional at least one network interface 406 includes a near field radio communication device that is limited to close proximity communication, such as a passive near field communication (NFC) tag, an active near field communication (NFC) tag, a passive radio frequency identification (RFID) tag, an active radio frequency identification (RFID) tag, a proximity card, or other personal area network device.

In examples, the optional at least one display device 408 includes at least one of a light emitting diode (LED), a liquid crystal display (LCD), a light emitting diode (LED) display, an organic light emitting diode (OLED) display, an e-ink display, a field emission display (FED), a surface-conduction electron-emitter display (SED), or a plasma display. In examples, the optional at least one input device 410 includes at least one of a touchscreen (including capacitive and resistive touchscreens), a touchpad, a capacitive button, a mechanical button, a switch, a dial, a keyboard, a mouse, a camera, a biometric sensor/scanner, a microphone, etc. In examples, the optional at least one display device 408 is combined with the optional at least one input device 410 into a human machine interface (HMI) for user interaction with the computing system(s) 400. In examples, optional at least one power source 412 is used to provide power to the various components of the computing system(s) 400.

The methods and techniques described herein may be implemented in digital electronic circuitry, or with a programmable processor (for example, a special-purpose processor or a general-purpose processor such as a computer) firmware, software, or in various combinations of each. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instruction to, a data storage system, at least one input device, and at least one output device. Generally, a processor will receive instructions and data from a read-only memory and/or a random-access memory. Storage devices suitable for tangibly embodying computer program instructions and data include all forms of non-volatile memory and storage media, including by way of example random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs), magneto-optical disks, and/or the like. Any of the foregoing may be supplemented by, or incorporated in, any known processor, such as a general purpose processor (GPP) or special purpose (such as a field-programmable gate array (FPGA), application-specific integrated circuit (ASIC) or other integrated circuit or circuitry), or any programmable logic device.

The components described above are meant to exemplify some types of possibilities. In no way should the aforementioned examples limit the disclosure, as they are only exemplary embodiments. The embodiments, structure, methods, etc. described herein, including those below and above, can be combined together in various ways.

### Terminology

Brief definitions of terms, abbreviations, and phrases used throughout this application are given below.

The terms “connected”, “coupled”, and “communicatively coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrase “based on” does not mean “based only on,” unless expressly specified otherwise. In other words, the phrase “based on” describes both “based only on” and “based at least on”. Additionally, the term “and/or” means “and” or “or”. For example, “A and/or B” can mean “A”, “B”, or “A and B”. Additionally, “A, B, and/or C” can mean “A alone,” “B alone,” “C alone,” “A and B,” “A and C,” “B and C” or “A, B, and C.”

The phrases “in exemplary embodiments”, “in example embodiments”, “in some embodiments”, “according to some embodiments”, “in the embodiments shown”, “in other embodiments”, “embodiments”, “in examples”, “examples”, “in some examples”, “some examples” and the like generally mean the particular feature, structure, or characteristic following the phrase is included in at least one embodiment of the present disclosure, and may be included in more than one embodiment of the present disclosure. In addition, such phrases do not necessarily refer to the same embodiments or different embodiments.

If the specification states a component or feature “may,” “can,” “could,” or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

Also, for the sake of illustration, various embodiments of the present disclosure have herein been described in the context of computer programs, physical components, and logical interactions within modern computer networks. Importantly, while these embodiments describe various embodiments of the present disclosure in relation to modern computer networks and programs, the method and apparatus described herein are equally applicable to other systems, devices, and networks as one skilled in the art will appreciate. As such, the illustrated applications of the embodiments of the present disclosure are not meant to be limiting, but instead are examples. Other systems, devices, and networks to which embodiments of the present disclosure are applicable include, for example, other types of communication and computer devices and systems. More specifically, embodiments are applicable to communication systems, services, and devices such as cell phone networks and compatible devices. In addition, embodiments are applicable to all levels of computing from the personal computer to large network mainframes and servers.

While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

### Examples

Example 1 includes a system, comprising: at least one processor; and at least one memory communicatively coupled to the at least one processor, the at least one memory storing computer readable instructions that when executed by the at least one processor causes the at least one processor to: receive at least one user defined quadratic polynomial equation modeling a specific model for operation of a non-linear process; receive updated coefficients for the at least one user defined quadratic polynomial equation modeling the specific model for the operation of the non-linear process; perform an economic load allocation based on the updated coefficients and the at least one user defined quadratic polynomial equation modeling the specific model for the operation of the non-linear process; derive optimized targets for at least one manipulated variable of the non-linear process based on the economic load allocation; and provide the optimized targets to hardware that adjusts the operation of the non-linear process.

Example 2 includes the system of Example 1, wherein the computer readable instructions, when executed by the at least one processor, causes the at least one processor to: receive the updated coefficients for the at least one user defined quadratic polynomial equation modeling the specific model for the operation of the non-linear process at least in part by being configured to: receive a bulk update with the updated coefficients from a user.

Example 3 includes the system of any of Examples 1-2, further comprising: wherein the hardware includes a plurality of secondary process controllers; and wherein the computer readable instructions, when executed by the at least one processor, causes the at least one processor to: receive the updated coefficients for the at least one user defined quadratic polynomial equation modeling the specific model for the operation of the non-linear process at least in part by being configured to: receive a bulk update with the updated coefficients from a user; and provide the optimized targets to the hardware that adjusts the operation of the non-linear process at least in part by being configured to: provide the optimized targets to the plurality of secondary process controllers to adjust the operation of the non-linear process across multiple sites.

Example 4 includes the system of any of Examples 1-3, wherein the computer readable instructions, when executed by the at least one processor, causes the at least one processor to: generate the updated coefficients based on real-time feedback from the non-linear process.

Example 5 includes the system of any of Examples 1-4, wherein the system comprises at least one of at least one plant wide optimizer or at least one process controller.

Example 6 includes the system of any of Examples 1-5, wherein the hardware includes at least one of a valve, a reactor, a pump, and a turbine.

Example 7 includes the system of any of Examples 1-6, wherein the hardware is remotely located from the at least one processor.

Example 8 includes the system of any of Examples 1-7, wherein the at least one user defined quadratic polynomial equation models the specific model for the operation of the non-linear process based on a least one of an oil to gas ratio, water, field reservoir pressure, gas re-injection, and well head pressure.

Example 9 includes a method comprising: receiving at least one user defined quadratic polynomial equation modeling a specific model for operation of a non-linear process; receiving updated coefficients for the at least one user defined quadratic polynomial equation modeling the specific model for the operation of the non-linear process; performing an economic load allocation based on the updated coefficients and the at least one user defined quadratic polynomial equation modeling the specific model for the operation of the non-linear process; deriving optimized targets for at least one manipulated variable of the non-linear process based on the economic load allocation; and providing the optimized targets to hardware that adjusts the operation of the non-linear process.

Example 10 includes the method of Example 9, wherein receiving the updated coefficients for the at least one user defined quadratic polynomial equation modeling the specific model for the operation of the non-linear process at least in part by: receiving a bulk update with the updated coefficients from a user.

Example 11 includes the method of any of Examples 9-10, wherein: receiving the updated coefficients for the at least one user defined quadratic polynomial equation modeling the specific model for the operation of the non-linear process at least in part by: receiving a bulk update with the updated coefficients from a user; and providing the optimized targets to the hardware that adjusts the operation of the non-linear process at least in part by: providing the optimized targets to a plurality of secondary process controllers to adjust the operation of the non-linear process across multiple sites.

Example 12 includes the method of any of Examples 9-11, further comprising: generating the updated coefficients based on real-time feedback from the non-linear process.

Example 13 includes the method of any of Examples 9-12, wherein the hardware includes at least one of a valve, a reactor, a pump, and a turbine.

Example 14 includes the method of any of Examples 9-13, wherein the hardware is remotely located from where the optimized targets are derived.

Example 15 includes a non-transitory computer-readable medium including a set of instructions that, when executed by at least one processor, cause the at least one processor to: receive at least one user defined quadratic polynomial equation modeling a specific model for operation of a non-linear process; receive updated coefficients for the at least one user defined quadratic polynomial equation modeling the specific model for the operation of the non-linear process; perform an economic load allocation based on the updated coefficients and the at least one user defined quadratic polynomial equation modeling the specific model for the operation of the non-linear process; derive optimized targets for at least one manipulated variable of the non-linear process based on the economic load allocation; and provide the optimized targets to hardware that adjusts the operation of the non-linear process.

Example 16 includes the non-transitory computer-readable medium of Example 15, wherein the set of instructions, when executed by the at least one processor, causes the at least one processor to: receive the updated coefficients for the at least one user defined quadratic polynomial equation modeling the specific model for the operation of the non-linear process at least in part by being configured to: receive a bulk update with the updated coefficients from a user.

Example 17 includes the non-transitory computer-readable medium of any of Examples 15-16, wherein the set of instructions, when executed by the at least one processor, causes the at least one processor to: receive the updated coefficients for the at least one user defined quadratic polynomial equation modeling the specific model for the operation of the non-linear process at least in part by being configured to: receive a bulk update with the updated coefficients from a user; and provide the optimized targets to the hardware that adjusts the operation of the non-linear process at least in part by being configured to: provide the optimized targets to a plurality of secondary process controllers to adjust the operation of the non-linear process across multiple sites.

Example 18 includes the non-transitory computer-readable medium of any of Examples 15-17, wherein the set of instructions, when executed by the at least one processor, causes the at least one processor to: generate the updated coefficients based on real-time feedback from the non-linear process.

Example 19 includes the non-transitory computer-readable medium of any of Examples 15-18, wherein the hardware includes at least one of a valve, a reactor, a pump, and a turbine.

Example 20 includes the non-transitory computer-readable medium of any of Examples 15-19, wherein the hardware is remotely located from the at least one processor.

What is claimed is:

1. A system, comprising:
at least one processor; and
at least one memory communicatively coupled to the at least one processor, the at least one memory storing computer readable instructions that when executed by the at least one processor causes the at least one processor to:
receive at least one user defined quadratic polynomial equation modeling a specific model for operation of a non-linear process;
receive updated coefficients for the at least one user defined quadratic polynomial equation modeling the specific model for the operation of the non-linear process;
perform an economic load allocation based on the updated coefficients and the at least one user defined quadratic polynomial equation modeling the specific model for the operation of the non-linear process;
derive optimized targets for at least one manipulated variable of the non-linear process based on the economic load allocation; and
provide the optimized targets to hardware that adjusts the operation of the non-linear process.

2. The system of claim 1, wherein the computer readable instructions, when executed by the at least one processor, causes the at least one processor to:
receive the updated coefficients for the at least one user defined quadratic polynomial equation modeling the specific model for the operation of the non-linear process at least in part by being configured to:
receive a bulk update with the updated coefficients from a user.

3. The system of claim 1, further comprising:
wherein the hardware includes a plurality of secondary process controllers; and
wherein the computer readable instructions, when executed by the at least one processor, causes the at least one processor to:
receive the updated coefficients for the at least one user defined quadratic polynomial equation modeling the specific model for the operation of the non-linear process at least in part by being configured to:
receive a bulk update with the updated coefficients from a user; and
provide the optimized targets to the hardware that adjusts the operation of the non-linear process at least in part by being configured to:
provide the optimized targets to the plurality of secondary process controllers to adjust the operation of the non-linear process across multiple sites.

4. The system of claim 1, wherein the computer readable instructions, when executed by the at least one processor, causes the at least one processor to:
generate the updated coefficients based on real-time feedback from the non-linear process.

5. The system of claim 1, wherein the system comprises at least one of at least one plant wide optimizer or at least one process controller.

6. The system of claim 1, wherein the hardware includes at least one of a valve, a reactor, a pump, and a turbine.

7. The system of claim 1, wherein the hardware is remotely located from the at least one processor.

8. The system of claim 1, wherein the at least one user defined quadratic polynomial equation models the specific model for the operation of the non-linear process based on a least one of an oil to gas ratio, water, field reservoir pressure, gas re-injection, and well head pressure.

9. A method comprising:
receiving at least one user defined quadratic polynomial equation modeling a specific model for operation of a non-linear process;
receiving updated coefficients for the at least one user defined quadratic polynomial equation modeling the specific model for the operation of the non-linear process;
performing an economic load allocation based on the updated coefficients and the at least one user defined quadratic polynomial equation modeling the specific model for the operation of the non-linear process;
deriving optimized targets for at least one manipulated variable of the non-linear process based on the economic load allocation; and
providing the optimized targets to hardware that adjusts the operation of the non-linear process.

10. The method of claim 9, wherein receiving the updated coefficients for the at least one user defined quadratic polynomial equation modeling the specific model for the operation of the non-linear process at least in part by:
receiving a bulk update with the updated coefficients from a user.

11. The method of claim 9, wherein:
receiving the updated coefficients for the at least one user defined quadratic polynomial equation modeling the specific model for the operation of the non-linear process at least in part by:
receiving a bulk update with the updated coefficients from a user; and
providing the optimized targets to the hardware that adjusts the operation of the non-linear process at least in part by:
providing the optimized targets to a plurality of secondary process controllers to adjust the operation of the non-linear process across multiple sites.

12. The method of claim 9, further comprising:
generating the updated coefficients based on real-time feedback from the non-linear process.

13. The method of claim 9, wherein the hardware includes at least one of a valve, a reactor, a pump, and a turbine.

14. The method of claim 9, wherein the hardware is remotely located from where the optimized targets are derived.

15. A non-transitory computer-readable medium including a set of instructions that, when executed by at least one processor, cause the at least one processor to:
receive at least one user defined quadratic polynomial equation modeling a specific model for operation of a non-linear process;
receive updated coefficients for the at least one user defined quadratic polynomial equation modeling the specific model for the operation of the non-linear process;
perform an economic load allocation based on the updated coefficients and the at least one user defined quadratic polynomial equation modeling the specific model for the operation of the non-linear process;
derive optimized targets for at least one manipulated variable of the non-linear process based on the economic load allocation; and
provide the optimized targets to hardware that adjusts the operation of the non-linear process.

16. The non-transitory computer-readable medium of claim 15, wherein the set of instructions, when executed by the at least one processor, causes the at least one processor to:
receive the updated coefficients for the at least one user defined quadratic polynomial equation modeling the specific model for the operation of the non-linear process at least in part by being configured to:
receive a bulk update with the updated coefficients from a user.

17. The non-transitory computer-readable medium of claim 15, wherein the set of instructions, when executed by the at least one processor, causes the at least one processor to:
receive the updated coefficients for the at least one user defined quadratic polynomial equation modeling the specific model for the operation of the non-linear process at least in part by being configured to:
receive a bulk update with the updated coefficients from a user; and
provide the optimized targets to the hardware that adjusts the operation of the non-linear process at least in part by being configured to:
provide the optimized targets to a plurality of secondary process controllers to adjust the operation of the non-linear process across multiple sites.

18. The non-transitory computer-readable medium of claim 15, wherein the set of instructions, when executed by the at least one processor, causes the at least one processor to:
generate the updated coefficients based on real-time feedback from the non-linear process.

19. The non-transitory computer-readable medium of claim 15, wherein the hardware includes at least one of a valve, a reactor, a pump, and a turbine.

20. The non-transitory computer-readable medium of claim 15, wherein the hardware is remotely located from the at least one processor.
